(19) United States
(12) Patent Application Publication
(10) Pub. No.: US 2005/0283382 A1
(43) Pub. Date: Dec. 22, 2005

(54) System and method for managing and tracking the location of patients and health care facility resources in a health care facility

(75) Inventors: Daniel J. Donoghue, Oregon, WI (US); James Ferris, Madison, WI (US); Handy Patriawan, Madison, WI (US); Steven J. Larsen, Cross Plains, WI (US); Christopher C. Spotts, McFarland, WI (US); Christopher J. Alban, Madison, WI (US)

Correspondence Address: GODFREY & KAHN S.C., 780 NORTH WATER STREET, MILWAUKEE, WI, 53202, US

(73) Assignee: Epic Systems Corporation

(21) Appl. No.: 11/077,068

(22) Filed: Mar. 10, 2005

Related U.S. Application Data
(60) Provisional application No. 60/581,866, filed on Jun. 21, 2004.

(51) Int. Cl. G06Q 10/00

(52) U.S. Cl. 705/2; 340/539.1

(57) ABSTRACT

Disclosed is a system and method for managing and tracking the location of patients and health care facility resources, including but not limited to health care practitioners, health care equipment, patient charts and other items in a health care facility. The system comprises a health care information system having at least one data repository for storing health care facility data, patient data and health care facility resource data and at least one graphical user interface in communication with the at least one data repository, and a graphical representation of at least one health care facility stored in the health care information system and displayable by the graphical user interface for managing patient care and health care facility resources. The graphical representation preferably provides an interactive map of the at least one health care facility for tracking the location of patients and health care facility resources.

### CROSS-REFERENCE TO RELATED APPLICATIONS

This application is based on and claims the benefit of U.S. Provisional Application No. 60/581,866, filed on Jun. 21, 2004, and is a Continuation-in-Part of U.S. application Ser. No. ______.

### BACKGROUND OF THE INVENTION

The present invention relates generally to health care management and health care facility resource management, and more particularly, to a system and method for managing and tracking the location of patients and health care facility resources in a health care facility. The health care facility resources are defined to include health care practitioners, health care equipment, patient charts and other items

Health care facilities provide for patient care. To provide patient care, it is necessary to maintain many types of information for patients. Access to this information is typically provided through a variety of software applications, usually related to the type of service being performed. In addition to providing patient care, health care facilities must manage many aspects of patient care. For example, health care facilities must manage patient admissions, discharges and transfers, appointment and procedure scheduling, billing and insurance information, and patient location and status. To effectively manage all aspects of patient care, health care facilities currently use a wide variety of health care management systems. Traditional health care management systems include paper charts and manually updated display boards. Recent upgrades in health care management systems include electronic systems that store, display, and facilitate the management of patient data. Most of these systems display information in a tabular format, but some include a display formatted to show patient room or bed locations. One such electronic system is disclosed in U.S. Patent Publication No. 2003/0074222, published Apr. 17, 2003. However, this system is limited to managing patient bed assignments and bed occupancy levels in a health care facility.

There are several limitations associated with these centralized bed management systems. First, the tabular displays are not very intuitive, especially to users who are new to a health care facility or new to health care management systems. A display showing a graphical representation or a map of the health care facility is more intuitive and easier to use. The prior art electronic systems that do have the capability of showing patient room or bed locations are also limited. Typically, those systems do not show an accurate graphical representation or map of the actual health care facility, but instead show a generic graphical representation of a typical facility. Also, the prior art systems are not able to track patients or health care facility resources, such as practitioners, equipment, patient charts and other items through the health care facility. Another significant limitation of the prior art systems is the fact that users cannot perform health care management actions on patients from the graphical representation or map display, such as admitting, discharging and transferring patients, assigning medical treatment teams to patients, scheduling patient appointments, ordering patient medications, and entering patient demographic, billing or insurance information. These actions must typically be performed using one or more separate health care management software applications.

Given the limitations and problems associated with the prior art systems and methods described above, there exists a need for an improved health care management system that is able to display an accurate graphical representation of a health care facility for tracking patients and health care facility resources including practitioners, equipment, patient charts and other items, and managing patient care and health care facility resources by displaying patient, practitioner, equipment and patient chart locations on an accurate graphical representation and allowing users to perform health care management actions on patients and facility resources without moving between separate software applications. The present invention provides improvements over the prior art systems and methods described above, and provides solutions to problems raised or not solved thereby.

### SUMMARY OF THE INVENTION

The present invention provides a system and method for managing and tracking the location of patients and health care facility resources including health care practitioners, health care equipment, patient charts, and other items in a health care facility. The system comprises a health care information system having at least one data repository for storing health care facility data, patient data and health care facility resource data and at least one graphical user interface in communication with the at least one data repository, and a graphical representation of at least one health care facility stored in the health care information system and displayable by the graphical user interface for managing patient care and health care facility resources. The graphical representation preferably provides an interactive map of the at least one health care facility for tracking the location of and performing actions on patients and health care facility resources including health care practitioners, health care equipment, patient charts and other items, and also preferably provides the ability to search for patients and health care facility resources, and show where they are located in the health care facility. Each interactive map is preferably developed from the health care facility blue prints or the actual physical layout of the facility, with each patient and health care facility resource being identifiable using radio frequency, infrared, global positioning system or bar code technology.

The method includes the steps of providing access to a graphical representation of a health care facility for displaying patient locations and health care facility resource locations including health care practitioner locations, health care equipment locations and patient chart locations in the health care facility, equipping patients and health care facility resources, such as health care practitioners, health care equipment, patient charts and other items in the health care facility with a device recognizable by a tracking system, locating a selected patient or health care facility resource, such as a health care practitioner, health care equipment or patient chart using the tracking system, and displaying the location of the selected patient or health care facility resource, such as the health care practitioner, health care equipment or patient chart on the graphical representation.

The present invention has several advantages over prior art systems and methods. For example, the graphical representation of the present invention is more intuitive, allowing users to see the data they need in a more efficient manner. The more intuitive graphical representation also makes the interactive map system easier to learn and operate, especially for those who are new to a health care facility or new to the interactive map system. The fact that the graphical representation is a realistic one based on the facility blue prints or the actual physical layout of the facility instead of a generic graphical representation makes the system even more intuitive and efficient. Another advantage of the present invention is the ability to perform tasks or health care management actions directly from the interactive map, eliminating the need to switch to one or more separate systems. The present invention allows users to perform actions like, among others, updating patient status, admitting, transferring and discharging patients, assigning treatment teams to patients, ordering patient medications and patient procedures, and entering and updating patient demographic, billing and insurance information.

Various other features, objects, and advantages of the invention will be made apparent to those skilled in the art from the accompanying drawings and detailed description thereof.

### BRIEF DESCRIPTION OF THE DRAWINGS

FIG. 1 is a block diagram of an enterprise health care information system in accordance with an embodiment of the present invention; and

FIG. 2 is a graphical representation of an interactive map of a health care facility in accordance with an embodiment of the present invention.

### DETAILED DESCRIPTION OF THE INVENTION

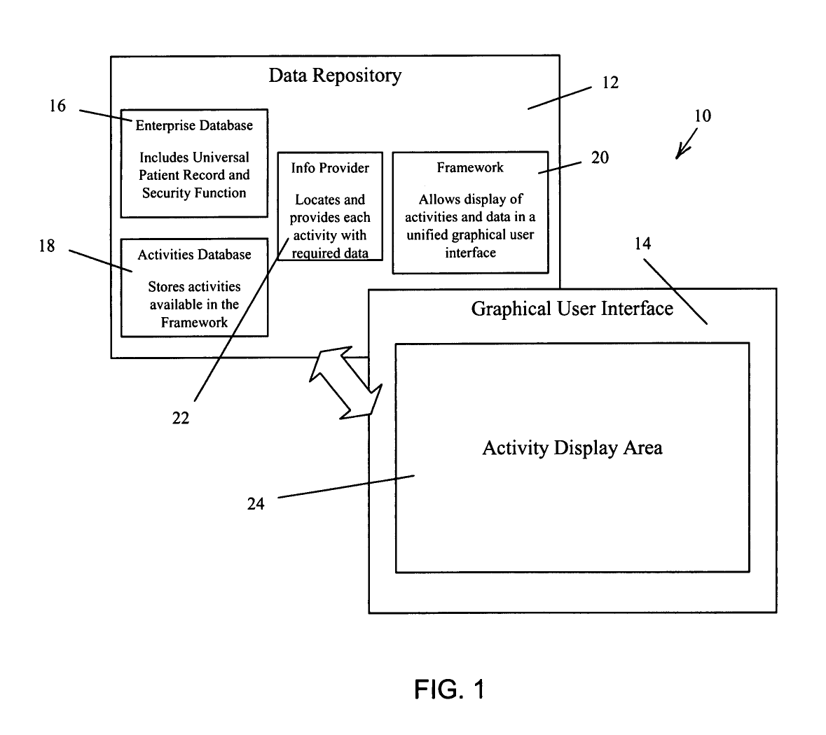

Referring now to the drawings, FIG. 1 is a block diagram of an enterprise health care information system 10 of the present invention. The enterprise health care information system 10 provides integration of health care records and health care records management, and facilitates access to health care records in a health care environment. The enterprise health care information system preferably comprises a plurality of integrated software applications and allows users to move between the plurality of software applications.

The integrated enterprise health care information system 10 preferably includes at least one data repository 12 for storing data and at least one graphical user interface 14 for accessing data. The data repository 12 is in communication with the graphical user interface 14. The data repository 12 preferably stores information related to system users and patients, including an enterprise database 16 with a universal patient record having data collected for each patient and security functions defining security parameters for system users, and an activities database 18. The universal patient record preferably includes information related to health care delivery for a patient, and information related to health care delivery management for the patient. System users have access to the universal patient record through one or more user interfaces in communication with the universal patient record. The security functions provide the ability to limit access to patient data displayable in the graphical representation of the health care facility and provide the ability to enable/disable actions performable on patients and health care facility resources displayable in the graphical representation of the health care facility. The data repository 12 further includes a modular framework 20 for supporting a plurality of patient care and health care facility resource management activities and an information provider 22 for providing each activity with its required data in communication with each other, and in communication with the enterprise database 16 and the activities database 18 which stores a plurality of activities for providing various aspects of patient care. These activities include, but are not limited to, activities used in providing health care to a patient and activities used in managing the health care provided to the patient.

The graphical user interface 14 provides a user access to the enterprise health care information system 10. The graphical user interface 14 displays information corresponding to one or more of the above-mentioned activities, and includes a common menu format for communicating available aspects in the graphical user interface, and common visual components for displaying information to the system user in an activity display area 24.

The enterprise health care information system 10 is designed to manage all aspects of a patient's health care including complete clinical, financial, and operational data relating to the patient through the use of the framework 20 for supporting a plurality of health care management activities that are stored in the activities database 18. Each health care management activity is preferably designed to manage a specific aspect of patient care. The framework 20 is preferably an integrated modular framework that allows users to easily move from one health care management activity to another using the information provider 22 in communication with the enterprise database 16 and the activities database 18.

In a preferred embodiment of the invention, the graphical user interface 14 comprises a display area 24 for displaying a graphical representation of at least one health care facility. The graphical representation is preferably an interactive map of the at least one health care facility stored in the data repository 12. Because the graphical representation of the at least one health care facility is integrated within the enterprise health care information system 10, it allows a user to visually locate patients, practitioners, health care facility resources, patient charts and other items within the health care facility, provide access to patient data and health care facility resource data, perform actions on the displayed patients and health care facility resources, and manage patient care and health care facility resources.

The graphical representation preferably provides an interactive map of a health care facility. The interactive map shown in the drawings is a sample interactive map developed to illustrate the features of the present invention. The interactive maps are preferably developed from actual facility blue prints or the actual physical layout of the health care facility to provide an accurate visual representation of the health care facility. The health care information system preferably includes a map building tool for creating the graphical representation of the health care facility from actual facility blue prints or the actual physical layout of the health care facility. The interactive maps provide an intuitive visual illustration of the health care facility, and are not limited to floor plans but are a realistic graphical representation of the health care facility. The interactive maps are preferably two-dimensional or three-dimensional graphical representations.

The present invention can display a graphical representation of an entire health care campus having a number of health care facilities or a single health care facility. A user can then select one building to see an interactive map of that health care facility down to the individual floors, rooms, resources, beds and patients. The graphical representation can be an interactive map of any health care facility, including but not limited to an inpatient facility, an outpatient facility, a hospital, an emergency department of a health care facility, an intensive care unit of a health care facility, a surgical department of a health care facility, a clinic, a nursing home, or an assisted living center. In addition, the graphical representation is preferably configurable and customizable based on the user's or facility's particular needs and preferences.

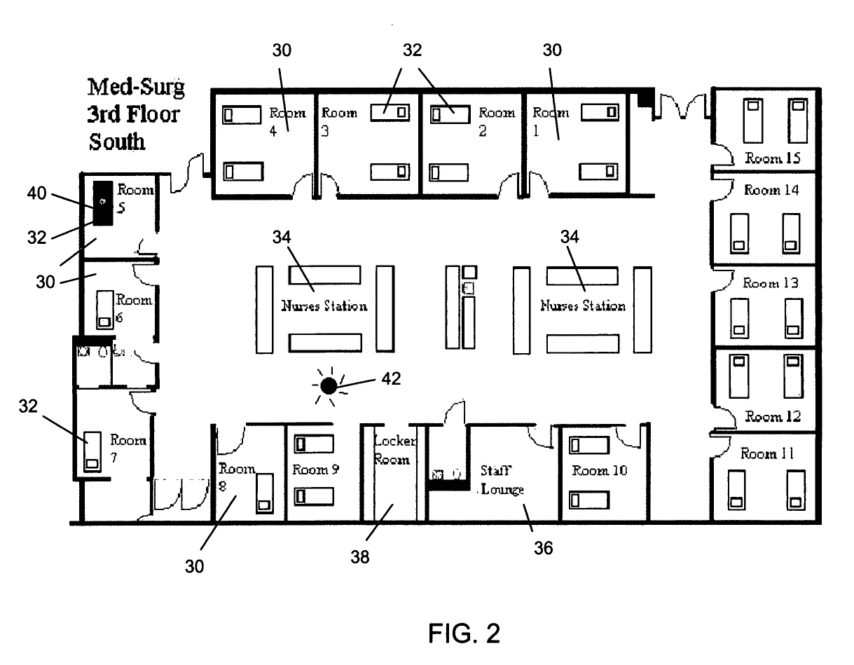

FIG. 2 is a graphical representation of a health care facility in accordance with an embodiment of the present invention. FIG. 2 shows an interactive map of a surgical facility, including patient rooms 30, patient beds 32, nurses stations 34, a staff lounge 36, a locker room 38, a patient 40 in a bed 32, and various hallways, exits, doorways and restrooms. Each interactive map can be customized for each health care facility based on the actual facility layout of the facility and the users' preferences. FIG. 2 also shows a flashing visual indicator 42 to indicate the location of a selected patient or health care facility resource, such as a health care practitioner, equipment or patient chart.

The interactive map of FIG. 2 can be used for tracking patients and health care facility resources, such as health care practitioners, equipment, patient charts and other items through the health care facility. Health care facility resources include all health care practitioners that work in the health care facility or have any contact with the health care facility or patients in the health care facility, including but not limited to doctors, nurses, physician's assistants, technicians, dieticians, nutritionists, police officers, counselors, pharmacists, nurse practitioners, emergency medical services personnel and medical students, and all resources used in the health care facility including but not limited to monitoring equipment, personal computers and medical devices. The interactive map provides the ability to search for patients and health care facility resources, including health care practitioners, health care equipment, patient charts and other items, and show where they are located in the health care facility.

*Each patient, health care practitioner, health care facility resource, patient chart or other item being tracked or located is identifiable by the present invention, preferably by equipping each item with a device recognizable by a tracking system. For example, a radio frequency (RF) tracking system could be used, wherein each item being tracked is equipped with a radio frequency identification tag (RFID). The RF tracking system would then be able to locate the item being tracked at any given time. Thus, if the emergency department needs a specific piece of equipment, the tracking system will be able to locate it by locating its RFID. The interactive map could then display the location of the equipment. In the same manner, the interactive map could display the locations of patients, health care practitioners, other health care facility resources, patient charts and other items. In addition to RF technology, other tracking system technologies could be used including infrared (IR) technology, bar code technology and global positioning system (GPS) technology. The locations of the tracked items could be displayed using visual indicators as described above, and could be displayed when a user requests that the system locate the particular item or selects a particular item to be located.

Some items, such as equipment, could be located by specific piece of equipment, or could be located by type of equipment. A classification system is preferably used to identify such items. For example, a personal computer could be identified by the tracking system as a specific personal computer, such as “PC #1,” and in general as type “PC.” Thus, a user could search for the locations of all the personal computers by requesting a search for “PC” or the user could search for the location of the specific personal computer by requesting a search for “PC #1.”Similarly, health care practitioners could be located individually or by type, allowing a user to locate “Dr. Smith” or any “cardiologist.”

In addition, health care practitioners or patients having identification tags could request that their location be displayed on the interactive map. For example, if a patient is crashing and in need of immediate assistance from a doctor, a nurse in the patient's room could activate a button or other device on her identification tag or the patient's identification tag that would cause an alert to be issued and displayed on the interactive map. The alert could be displayed as a visual indicator, such as a flashing red dot on the interactive map, to alert interactive map users that help is needed at that location. Alternatively, the alert could be issued through a paging or email notification system in communication with the enterprise health care information system.

The present invention could also provide patients and health care practitioners a map displaying their current location and the path to their next destination. The graphical representation can preferably provide both a graphical display of the path as well as a verbal or text-written set of directions. For example, if a patient needs to go from an examination room to a lab, the patient could locate herself on an interactive map using the tracking system, either by activating a button or other device on her identification tag or by requesting the system search for her, and request directions from that location to the lab. The directions would then be displayed on the interactive map, preferably both graphically and verbally or textually.

The graphical representation of the present invention is preferably accessible via a web browser for connection to the Internet, an intranet, or other wireless network. For example, users can preferably log in from remote locations as well as in the health care facility. The graphical representation of the present invention may also be oriented with respect to the location of the user. For example, if a user logs in to a computer facing a south wall of the health care facility, the graphical representation will preferably display a map showing the south wall of the facility as the “top” or facing wall in the graphical representation, such that the user will automatically see what items shown on the map are currently in front of her, behind her, and to the left and right of her. In other words, the user will not have to first determine where she is located with respect to the map.

The graphical representation can also preferably be used for performing actions on patients and health care facility resources displayed in the graphical representation of the health care facility. For example, the graphical representation can preferably be used for managing admissions, discharges and transfers of patients within the healthcare facility; admitting patients to the health care facility; assigning patients to rooms and beds of the health care facility; assigning treatment teams to patients; transferring patients within the health care facility; moving patients within the health care facility; swapping patients from one location to another in the health care facility; quarantining off an area for infection control; and discharging patients from the health care facility.

While the invention has been described with reference to preferred embodiments, those skilled in the art will appreciate that certain substitutions, alterations and omissions may be made to the embodiments without departing from the spirit of the invention. Accordingly, the foregoing description is meant to be exemplary only, and should not limit the scope of the invention as set forth in the following claims.

1. A system for managing and tracking the location of patients in a health care facility comprising:
a health care information system having at least one data repository for storing patient data and health care facility resource data, and at least one graphical user interface in communication with the at least one data repository; and
a graphical representation of at least one health care facility stored in the health care information system and displayable by the graphical user interface for managing patient care and health care facility resources.

2. The system of claim 1, wherein the graphical representation provides an interactive map of the at least one health care facility for tracking patient locations and performing actions on the patients.

3. The system of claim 1, wherein the graphical representation provides the ability to search for patients and show where they are located in the health care facility.

4. The system of claim 1, wherein each patient is identifiable.

5. The system of claim 1, wherein the health care facility incorporates RF technology for managing and tracking the location of patients in the health care facility.

6. The system of claim 1, wherein the health care facility incorporates IR technology for managing and tracking the location of patients in the health care facility.

7. The system of claim 1, wherein the health care facility incorporates GPS technology for managing and tracking the location of patients in the health care facility.

8. The system of claim 1, wherein the graphical representation provides the patients a map displaying their current location and the path to their next destination.

9. The system of claim 8, wherein the graphical representation includes both a graphical display of the path as well as a verbal or text-written set of directions.

10. A system for managing and tracking the location of health care facility resources in a health care facility comprising:
a health care information system having at least one data repository for storing patient data and health care facility resource data, and at least one graphical user interface in communication with the at least one data repository; and
a graphical representation of at least one health care facility stored in the health care information system and displayable by the graphical user interface for managing patient care and health care facility resources.

11. The system of claim 10, wherein the health care facility resources include but are not limited to health care practitioners, health care equipment and patient charts.

12. The system of claim 10, wherein the graphical representation provides an interactive map of the at least one health care facility for tracking health care facility resource locations.

13. The system of claim 10, wherein the graphical representation provides the ability to search for health care facility resources and show where they are located in the health care facility.

14. The system of claim 10, wherein each health care facility resource is identifiable.

15. The system of claim 10, wherein the health care facility incorporates RF technology for managing and tracking the location of health care facility resources in the health care facility.

16. The system of claim 10, wherein the health care facility incorporates IR technology for managing and tracking the location of health care practitioners in the health care facility.

17. The system of claim 10, wherein the health care facility incorporates GPS technology for managing and tracking the location of health care facility resources in the health care facility.

18. The system of claim 10, wherein the health care facility incorporates bar code technology for managing and tracking the location of health care facility resources in the health care facility.

19. The system of claim 11, wherein the graphical representation provides the health care practitioners a map displaying their current location and a path to their next destination.

20. The system of claim 19, wherein the graphical representation includes both a graphical display of the path as well as a verbal or textual written set of directions.

21. The system of claim 10, further comprising a classification system for identifying health care facility resources by type and individual unit.

22. A method for managing and tracking the location of patients in a health care facility, the method comprising the steps of:
providing access to a graphical representation of a health care facility for displaying patient locations in the health care facility;
equipping patients in the health care facility with a device recognizable by a tracking system;
locating a selected patient using the tracking system; and
displaying the location of the selected patient on the graphical representation.

23. The method of claim 22, wherein the graphical representation is an interactive map of the health care facility.

24. The method of claim 22, wherein the tracking system is an RF tracking system and the device is an RFID tag.

25. The method of claim 22, wherein the tracking system is an IR tracking system.

26. The method of claim 22, wherein the tracking system is a GPS tracking system.

27. A method for managing and tracking the location of health care facility resources in a health care facility, the method comprising the steps of:
providing access to a graphical representation of a health care facility for displaying health care facility resource locations in the health care facility;
equipping health care facility resources in the health care facility with a device recognizable by a tracking system;
locating a selected health care facility resource using the tracking system; and
displaying the location of the selected health care facility resource on the graphical representation.

28. The method of claim 27, wherein the health care facility resources include but are not limited to health care practitioners, health care equipment and patient charts.

29. The method of claim 27, wherein the graphical representation is an interactive map of the health care facility.

30. The method of claim 27, wherein the tracking system is an RF tracking system and the device is an RFID tag.

31. The method of claim 27, wherein the tracking system is an IR tracking system.

32. The method of claim 27, wherein the tracking system is a GPS tracking system.

33. The method of claim 27, wherein the tracking system is a bar code tracking system.
